(19) United States
(12) Patent Application Publication
(10) Pub. No.: US 2024/0411431 A1
(43) Pub. Date: Dec. 12, 2024

(54) METHOD FOR DISPLAYING MULTIMEDIA RESOURCE, ELECTRONIC DEVICE AND STORAGE MEDIUM

(71) Applicant: Beijing Dajia Internet Information Technology Co., Ltd., Beijing (CN)

(72) Inventors: Qiu Yang, Beijing (CN); Zhenrong Tian, Beijing (CN); Ge Song, Beijing (CN); Zhen Chen, Beijing (CN); Tianshu Li, Beijing (CN); Siyu Gu, Beijing (CN); Yingchun Wang, Beijing (CN); Xiaoyu Yang, Beijing (CN); Yichi Zhang, Beijing (CN)

(21) Appl. No.: 18/536,414

(22) Filed: Dec. 12, 2023

(30) Foreign Application Priority Data
Jun. 9, 2023 (CN) 202310686729.8

(51) Int. Cl. G06F 3/0484; G06F 3/0482

(52) U.S. Cl. CPC G06F 3/0484; G06F 3/0482

(57) ABSTRACT

The method for displaying a multimedia resource includes: displaying a first multimedia resource on a multimedia display page; in response to a scene selection instruction, displaying scene representation information respectively corresponding to at least one viewing scene on the multimedia display page in a process of displaying the first multimedia resource; in which the scene representation information is configured to represent a corresponding viewing scene, and enter the corresponding viewing scene to browse a multimedia resource under the corresponding viewing scene in response to the scene representation information being triggered.

### CROSS-REFERENCE TO RELATED APPLICATION

This application claims the priority to Chinese Patent Application No. 202310686729.8, filed on Jun. 9, 2023, the entire contents of which are incorporated herein by reference in their entireties.

### TECHNICAL FIELD

The disclosure relates to a field of data processing technology, in particular to a method for displaying a multimedia resource, an electronic device, and a storage medium.

### BACKGROUND

With the development of multimedia-based interaction applications, such as short video applications, in order to enhance a matching degree between a displayed short video and user's interests, in the related art, when a user slides up and down short videos, a non-video interface that provides different options of content types is inserted, which enables the user to select favorite content types of interest preference and to adjust levels of preference for different content types. Alternatively, an interface entry provided in a multimedia application is used to enter a content type screening page on which the user can select from a fixed number of content types.

### SUMMARY

According to a first aspect of the embodiments of the disclosure, a method for displaying a multimedia resource is provided. The method includes:
displaying a first multimedia resource on a multimedia display page;
in response to a scene selection instruction, displaying scene representation information respectively corresponding to at least one viewing scene on the multimedia display page in a process of displaying the first multimedia resource; in which
the scene representation information is configured to represent a corresponding viewing scene and enter the corresponding viewing scene to browse a multimedia resource under the viewing scene when the scene representation information is triggered.

According to a second aspect of the embodiments of the disclosure, an electronic device is provided. The electronic device includes: a processor and a memory for storing instructions executable by the processor. The processor is configured to execute the instructions to implement the method of any embodiment of the first aspect.

According to a third aspect of the embodiments of the disclosure, a computer-readable storage medium having instructions stored thereon is provided. When the instructions are executed by a processor of an electronic device, the electronic device is caused to implement the method of any embodiment of the first aspect.

It should be understood that the above general description and the following detailed description are exemplary and explanatory only and do not limit the disclosure.

### BRIEF DESCRIPTION OF THE DRAWINGS

The accompanying drawings, which are incorporated in and constitute a part of this description, illustrate embodiments consistent with the disclosure and, together with the description, serve to explain the principles of the disclosure and do not constitute an undue limitation of the disclosure.

FIG. 1 is a schematic diagram of an application environment according to an exemplary embodiment.

FIG. 2 is a flowchart of a method for displaying a multimedia resource according to an exemplary embodiment.

FIG. 3 is a schematic diagram of displaying a multimedia display page under a default display mode according to an exemplary embodiment.

FIG. 4a and FIG. 4b are schematic diagrams of displaying a multimedia preview scene and scene titles according to the exemplary embodiment.

FIG. 5 is a schematic diagram of incrementally displaying scene switching controls on the multimedia display page according to an exemplary embodiment.

FIGS. 6a and 6b are schematic diagrams of displaying multimedia preview scenes, scene titles, and scene switching controls on the multimedia display page according to an exemplary embodiment.

FIG. 7 is a schematic diagram of switching to browse scene representation information according to an exemplary embodiment.

FIG. 8 is a schematic diagram of displaying a multimedia resource according to an exemplary embodiment.

FIG. 9 is a schematic diagram of automatically play videos continuously in a viewing scene according to an exemplary embodiment.

FIG. 10 is a schematic diagram of a switching process of a viewing scene according to an exemplary embodiment.

FIG. 11 is a block diagram of an apparatus for displaying a multimedia resource according to an exemplary embodiment.

FIG. 12 is a block diagram of an electronic device for displaying a multimedia resource according to an exemplary embodiment.

### DETAILED DESCRIPTION

In order to enable those skilled in the art to better understand the technical solutions of the disclosure, the technical solutions in the embodiments of the disclosure will be clearly and completely described below with reference to the accompanying drawings.

It should be noted that the terms “first”, “second”, etc. in the specification and claims of the disclosure and the accompanying drawings are used to distinguish similar objects and do not indicate a particular order or sequence. It should be understood that the terms used in this way can be interchanged in appropriate cases, so that the embodiments of the disclosure described herein can be implemented in an order other than those illustrated or described herein. The embodiments described in the following exemplary embodiments do not represent all embodiments consistent with the disclosure. Instead, they are only examples of devices and methods consistent with some aspects of the disclosure as described in detail in the appended claims.

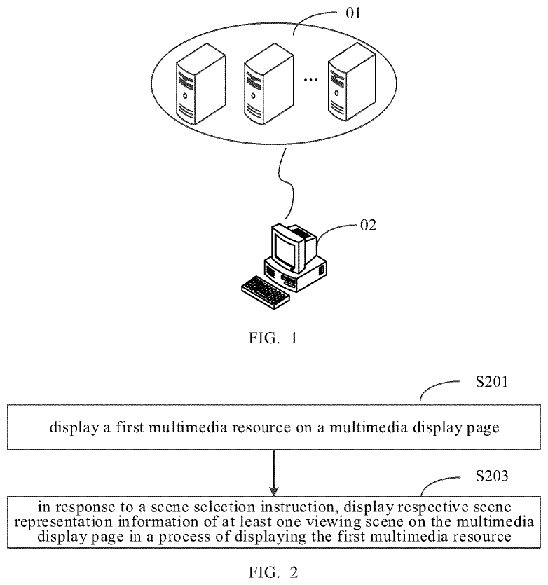

FIG. 1 is a schematic diagram of an application environment according to an exemplary embodiment. As illustrated in FIG. 1, the application environment includes: a plurality of servers 01 and a terminal 02.

In an optional embodiment, the terminal 02 may be used for displaying multimedia resources. The terminal 02 may include, but is not limited to, a smartphone, a desktop computer, a tablet computer, a laptop, a smart speaker, a digital assistant, an augmented reality (AR)/virtual reality (VR) device, a smart wearable device, and other types of electronic devices. Optionally, an operating system running on the electronic device may include, but is not limited to, android, IOS, linux, windows, and the like.

In an optional embodiment, the server 01 may be used to provide displayed multimedia resources for the terminal 02 and to dynamically adjust a recommendation strategy for the multimedia resources. In detail, the service 01 may be an independent physical server, a cluster of servers or a distributed system formed by a plurality of physical servers, or a cloud server that provides basic cloud computing services such as a cloud service, a cloud database, cloud computing, cloud functions, cloud storage, a network service, cloud communication, a middleware service, a domain name service, a security service, a content delivery network (CDN), a big data and artificial intelligence platform.

In addition, it is noted that FIG. 1 shows only one application environment of the method for displaying a multimedia resource provided by the disclosure.

In the embodiment of the disclosure, the server 01 and the terminal 02 may be connected directly or indirectly by means of wired or wireless communication, which is not limited in the disclosure.

It should be noted that the following figures illustrate a possible sequence of steps and does not actually specify that this sequence must be strictly followed. Some of the steps may be performed in parallel independently. The user information (including, but not limited to, user device information, user personal information, user behavior information, etc.) and data (including, but not limited to, data used for display, training data, etc.) involved in the disclosure are information and data authorized by the user or fully authorized by all parties.

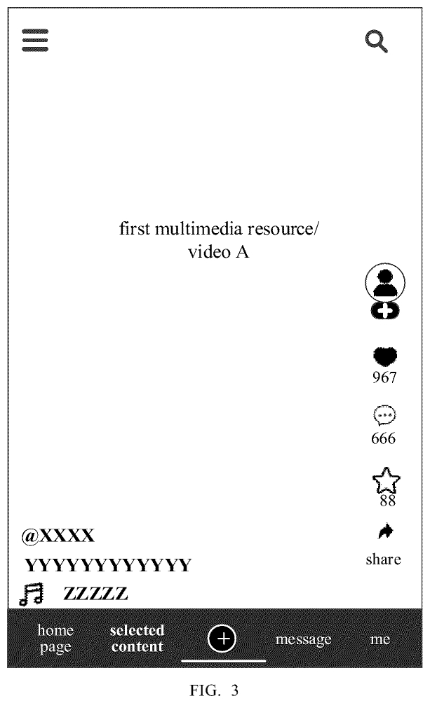

FIG. 2 is a flowchart of a method for displaying a multimedia resource according to an exemplary embodiment. The method can be performed by a terminal. As illustrated in FIG. 2, the method includes the following steps.

At step S201, a first multimedia resource is displayed on a multimedia display page.

In the embodiment of the disclosure, the multimedia display page may refer to a page for displaying a multimedia resource, such as a multimedia recommendation page for displaying recommended multimedia resources. For example, the multimedia display page may refer to an information flow page for displaying the recommended multimedia resources. For example, the multimedia resource may include, but is not limited to, a long video, a short video, etc. A mode for displaying the multimedia resource on the multimedia display page may include full-screen display, which is not limited in the disclosure.

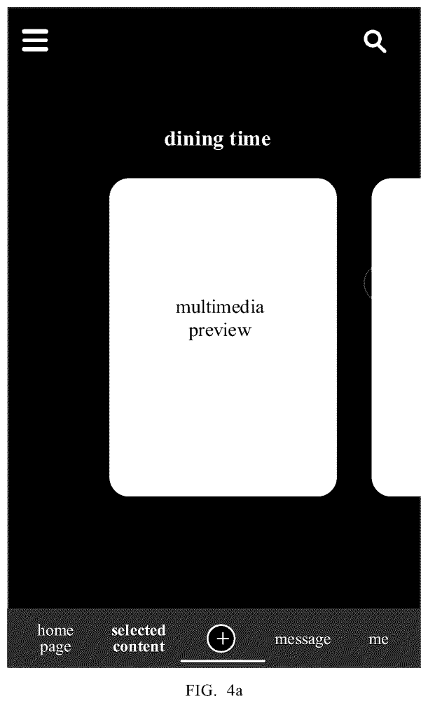

For example, as shown in FIG. 3, the multimedia display page may be a video display page (which may be regarded as a kind of multimedia recommendation page) with a single column of video streams, and the short video on the multimedia display page may be recommended based on the user's interest and preference, to conform to the user's need for short video browsing.

For example, on the multimedia display page, a user can browse different short videos by sliding up and down. Correspondingly, a currently browsed multimedia resource can be determined as the first multimedia resource. For example, by triggering a navigation control of “selected content” at the bottom of the page in FIG. 3, the multimedia recommendation page shown in FIG. 3 can be entered, so that different short videos can be browsed on the multimedia recommendation page. For example, the user switches to video A by a sliding operation, the video A can be displayed (or played) on the multimedia recommendation page, so that the currently displayed video A can be regarded as the first multimedia resource.

Optionally, the first multimedia resource may be a multimedia resource when no viewing scene is entered, i.e., a multimedia resource that is displayed in a default display mode described below. Alternatively, the first multimedia resource may be a multimedia resource under any viewing scene. The relevant contents of the viewing scene may refer to introduction below and will not be repeated herein.

At step S203, in response to a scene selection instruction, scene representation information corresponding to at least one viewing scene respectively is displayed on the multimedia display page in a process of displaying the first multimedia resource.

The scene representation information is configured to represent a corresponding viewing scene, and enter the corresponding viewing scene to browse one or more multimedia resources under the corresponding viewing scene when the scene representation information is triggered. Different viewing scenes can be used to realize a scene-of-interest viewing experience, which is different from viewing based on an interest content type. The viewing scenes can be regarded as multimedia viewing modes divided on the multimedia display page. For example, different time periods and different states can be used to classify scenes, which can satisfy the account' need for different interest preference scenes classified based on scene type. The viewing scene can represent the mode or state of viewing the multimedia, or different viewing scenes can be regarded as fine-grained recommendation scenes on the multimedia recommendation page. The multimedia resources displayed under each viewing scene can be recommended based on resource interaction information under each viewing scene, or they can also be randomly recommended, for example, in order to explore new content types.

The resource interaction information under each viewing scene may include historical resource interaction information of a target account interacting with the multimedia resources under each viewing scene. Alternatively, the resource interaction information is obtained based on statistics of the historical resource interaction information of a large number of accounts in a multimedia application interacting with the multimedia resources under each viewing scene. The multimedia application may refer to an application to which the multimedia display page belongs. The target account may refer to an account that triggers the scene selection instruction. The account here refers to identification information used in the multimedia application to distinguish different users, which is not limited in the disclosure.

It is noted that when the target account enters a viewing scene for the first time, the multimedia resources can be recommended based on the resource interaction information obtained by statistics above. In the case of continuously obtaining the historical resource interaction information of the target account, under the viewing scene, interacting with the multimedia resources displayed under the viewing scene, the multimedia resources can be recommended to the target account based on the historical resource interaction information of the target account under the viewing scene, so as to enhance the accuracy of recommendation of the target account under the viewing scene.

For example, the viewing scene may include a dining scene, a news scene, a mum & baby scene, etc. For example, the dining scene may be a viewing scene about dining time under which multimedia resources preferred by the account at the dining time may be recommended to the account. The multimedia resources preferred by the account at the dining time may be recommended by performing match on resource interaction information of the account under the viewing scene about the dining time. By recommending multimedia resources according to different scenes, the multimedia resource browsing need of the account under different scenes can be satisfied, and the operation is convenient.

In an optional implementation, statistics of the resource interaction information of the target account under each viewing scene may be performed independently, so that independent recommendation may be performed under different scenes based on the resource interaction information under each viewing scene. For example, at least one content tag preferred by an account under any viewing scene may be determined based on the resource interaction information of the account under any viewing scene, so as to screen out multimedia resources matching the at least one preferred content tag. For example, account A prefers music videos in a fitness scene, when the account A selects the fitness scene, music videos can be displayed. Alternatively, the account A prefers book explanation videos in a sleeping scene, when the account A selects the sleeping scene, book explanation videos can be displayed. In this way, it is not necessary to frequently set the preferred content tag, and the user can enter different viewing scenes conveniently based on different scenes, so that the viewing experience can be enhanced, and the browsing need of the account can be responded to more timely than adjusting the content tags.

The resource interaction information may refer to a duration of browsing a multimedia resource, and performing a preset operation on a multimedia resource, etc., which may include, but is not limited to, forwarding, commenting, and the like.

Optionally, the plurality of viewing scenes may be matched with the target account. The plurality of viewing scenes matched with the target account may be dynamically determined based on account attribute information of the target account, where dynamically determining may be determining a viewing scene matching with the account attribute information from a plurality of preset viewing scenes. Alternatively, the plurality of viewing scenes matched with the target account may be viewing scenes dynamically generated based on the account attribute information. Alternatively, the plurality of viewing scenes matched with the target account may be obtained by both of the above two methods, i.e., both the viewing scenes matched with the account attribute information screened from the plurality of preset viewing scenes and the viewing scenes dynamically generated based on the account attribute information are determined as the plurality of viewing scenes matched with the target account. Therefore, the plurality of viewing scenes are matched with the target account, which can realize customization of viewing scenes for different accounts and enhance the viewing experience. The preset viewing scenes can be preset based on the account attribute information of a large number of accounts, e.g., scenes such as a sleep scene, the dinning time, and so on.

For example, the account attribute information may include, but is not limited to, static attribute information, dynamic attribute information, status information, and the like. For example, the static attribute information may include gender and age. The dynamic attribute information may include user's interaction information, or information that changes over time and can represent account preferences, such as, preference information after entering into a workplace. The interaction information may refer to information about multimedia resource interaction in a multimedia application. The state information may include an exercise state, a vacation state, a dining state, a sleeping state, and the like, which is not limited in the disclosure.

In the embodiment of the disclosure, displaying the scene representation information respectively corresponding to a plurality of viewing scenes on the multimedia display page in the process of displaying the first multimedia resource may include any one of the followings: incrementally displaying the scene representation information respectively corresponding to the plurality of viewing scenes on the multimedia display page, or performing switching display on the scene representation information respectively corresponding to the plurality of viewing scenes on the multimedia display page.

The incrementally displaying may include, but is not limited to, a way of pop-up window, a way of floating layer, a way of shrinking a display area of the first multimedia resource to provide a display area for displaying the scene representation information. Performing the switching display may refer to replacing the first multimedia resource, for example, hiding the first multimedia resource, and replacing the first multimedia resource with the scene representation information, or replacing the first multimedia resource with a certain navigation control, which is not limited in the disclosure.

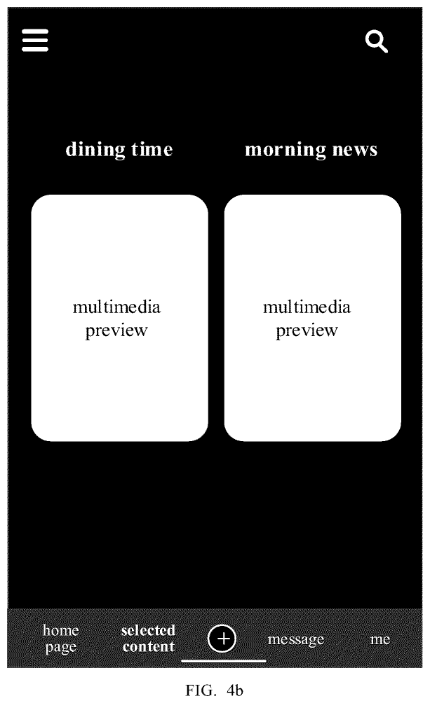

In an example, as illustrated in FIG. 4a and FIG. 4b, the scene representation information may include multimedia preview information and a corresponding scene title. The multimedia preview information may be multimedia preview information displayed in an area where the multimedia preview is located as illustrated in FIG. 4a and FIG. 4b. The scene title may be text information describing a viewing scene, such as dining time and morning news as illustrated in FIG. 4a and FIG. 4b. Correspondingly, step S203 may include: in the process of displaying the first multimedia resource, in response to the scene selection instruction, switching on the multimedia display page to display the multimedia preview information and the corresponding scene title corresponding to the at least one viewing scene. For example, multimedia preview information and a corresponding scene title of a viewing scene may be displayed as shown in FIG. 4a, and the first multimedia resource and other information (e.g., an interaction control on the right side and the interaction information on the lower left side in FIG. 3) are hidden. In this way, the multimedia preview information can be fully displayed to facilitate the understanding of the corresponding viewing scene. Alternatively, multimedia preview information and corresponding scene titles of multiple viewing scenes may be displayed, for example, the multimedia preview information and the corresponding scene titles of two viewing scenes shown in FIG. 4B, which may enhance the utilization rate of display resources. The display mode of the multimedia preview information is not limited in the disclosure, as long as the multimedia preview information can be displayed effectively. The viewing scene can be represented by the multimedia preview information, to facilitate understanding and provide the basis for accurate selection of the viewing scene.

For example, the multimedia preview information may be displayed in the form of a card, which is not limited in the disclosure. In FIG. 4a and FIG. 4b, “dining time” and “morning news” may refer to scene titles.

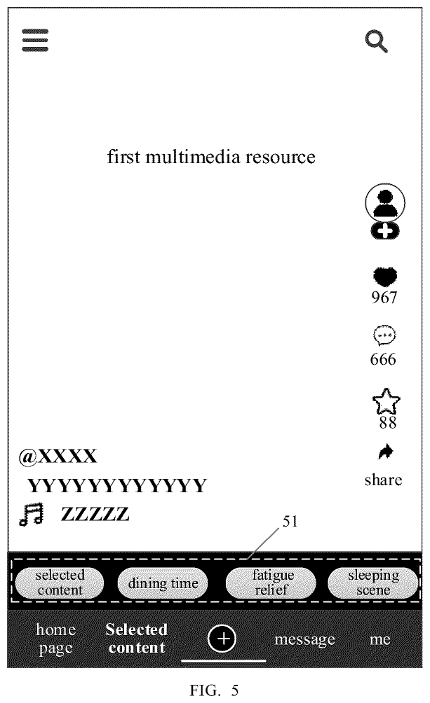

In another example, as illustrated in FIG. 5, the scene representation information may include at least one scene switching control, such as 51 in FIG. 5. In this case, step S203 may include: in response to the scene selection instruction, shrinking a display area of the first multimedia resource and incrementally displaying at least one scene switching control on the multimedia display page in the process of displaying the first multimedia resource.

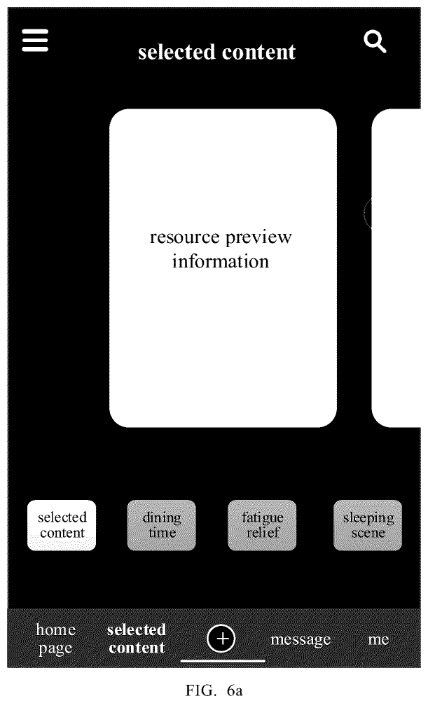

In another example, the scene representation information may include multimedia preview information and at least one scene switching control. Optionally, as illustrated in FIGS. 6a and 6b, the scene representation information may include the multimedia preview information, a corresponding scene title, and the scene switching controls. As illustrated in FIGS. 6a and 6b, the scene title may be located above the multimedia preview information, to illustrate the viewing scene corresponding to the multimedia preview information. The scene switching controls may be located above the multimedia preview information, or the scene switching controls may be located below the multimedia preview information, and the relative location between the multimedia preview information and the scene switching controls is not limited in the disclosure.

In a possible implementation, the scene selection instruction may be triggered by a following manner. In response to interaction information of a target account on the multimedia display page not satisfying an interaction condition, the scene selection instruction is generated. The interaction information may refer to interaction information of the target account interacting with a multimedia resource displayed on the multimedia display page within a certain duration after the target account enters the multimedia display page, for example, a total viewing time, a number of forwarding times, etc., which is not limited in the disclosure.

The interaction information not satisfying the interaction condition may be used to represent that the multimedia resource displayed on the multimedia display page does not match content preferences of the target account within the certain duration after the target account enters the multimedia display page. For example, the interaction condition may include a total viewing time threshold, a threshold for forwarding times, and the like, which is not limited in the disclosure.

Correspondingly, the triggering method of the scene selection instruction may include at least one of the followings: a shrinking operation on a display page of the first multimedia resource, or a display duration of a multimedia resource not reaching a duration threshold, etc. In response to the interaction information of the target account on the multimedia display page not satisfying the interaction condition, the scene selection instruction is generated in the process of displaying the first multimedia resources, to satisfy the need of switching scenes of the account in time.

Alternatively, the scene selection instruction may be triggered in at least one of the following ways: a shrinking operation on a display page of the first multimedia resource, a preset operation mode existing on the multimedia display page, or a current time point being within a preset scene selection time period. The preset operation method may include, but is not limited to, a long press on the screen, double-clicking an area where the first multimedia resource is located, a preset interaction gesture, a preset sliding operation, triggering a preset route (e.g., S-shape, L-shape, and other routes), triggering a preset control, triggering an update control changed from an existing control, and triggering a customized control on the screen. The scene selection time period may include, but is not limited to, a time period for morning news, a lunch time period, and a sports time period. The scene selection instruction can be generated by various triggering ways, to enhance the flexibility and richness of scene selection.

In practice application, for example, during the process of displaying the first multimedia resource, a shrinking operation may be performed on a display page of the first multimedia resource to trigger the scene selection instruction. Correspondingly, in response to the scene selection instruction, the scene representation information respectively corresponding to a plurality of viewing scenes may be displayed on the multimedia display page, as described in any one of FIG. 4a to FIG. 6b.

In the process of displaying the first multimedia resource, in response to the scene selection instruction, the scene representation information respectively corresponding to the at least one viewing scene is displayed on the multimedia display page. The scene representation information is configured to represent a corresponding viewing scene and enter the viewing scene to browse the multimedia resource under the viewing scene when scene representation information is triggered. Therefore, the user can efficiently and conveniently switch to the preferred viewing scene according to the current state, thus can browse the multimedia resources of interest without readjusting the preferred content types, which provides the user with more precise choices of scenes for displaying multimedia.

Moreover, the viewing scene can effectively reflect the user's viewing state, thus it is easy to understand, so that the user can accurately and conveniently choose the preferred viewing scene, thereby improving the multimedia resource browsing experience and improving the utilization rate of display resources. The scene representation information respectively corresponding to the at least one viewing scene is also displayed on the multimedia display page, which makes the operation more convenient.

In addition, the preferred content types do not need to be adjusted, the multimedia is displayed on the multimedia display page according to different scenes, which allows for displaying corresponding multimedia under each viewing scene and does not fix the overall content types of multimedia resources displayed on the multimedia display page. In this way, the browsing needs of the users in different states or at different times can be satisfied flexibly, and the overall impact on displaying the multimedia resources on the multimedia display page can be avoided.

In a possible implementation, the at least one viewing scene may be a plurality of viewing scenes, the scene representation information may include multimedia preview information and corresponding scene titles, or the scene representation information may include a plurality of scene switching controls, or the scene representation information may include the multimedia preview information and a plurality of scene switching controls.

Correspondingly, when the scene representation information includes the multimedia preview information and the plurality of scene switching controls, the method may also include switching and browsing of the multimedia preview information or the plurality of scene switching controls, and the method further includes:
in response to a switching instruction for a plurality of pieces of multimedia preview information, switching between the plurality of pieces of multimedia preview information for display, and controlling the plurality of scene switching controls to switch following the display of the plurality of pieces of multimedia preview information; or
in response to a switching instruction for the plurality of scene switching controls, switching between the plurality of scene switching controls for display, and controlling the plurality of pieces of multimedia preview information to switch following the display of the plurality of scene switching controls.

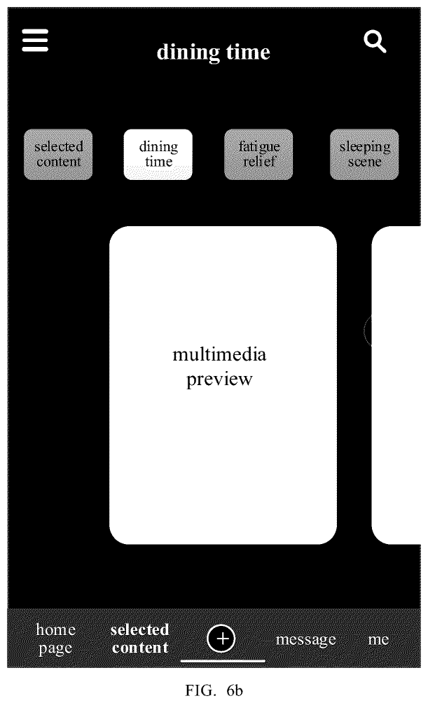

As illustrated in FIG. 7, the user can slide to left or right on the multimedia preview information, for example, if sliding left it may switch to display multimedia preview information under the viewing scene of dining time, and the scene switching controls are displayed correspondingly, following the switching of the display of the multimedia preview information. For example, the scene switching control for “dining time” in FIG. 7 changes to a light color, which is different from other scene switching controls and a “selected content” control. The style of display following of the scene switching controls is not limited in the disclosure.

Alternatively, the scene switching control can be switched by sliding to left or right. For example, as shown in FIG. 7, the user can slide to the left to switch from “dining time” scene to a sleeping scene. Correspondingly, the multimedia preview information above the scene switching controls is also switched, following the switch of the scene switching controls, to display the multimedia preview information under the sleeping scene.

By switching and browsing the multimedia preview information or the scene switching controls, the multimedia preview information and the scene switching controls can be displayed in cooperation, thus the user not only can quickly understand the content under each viewing scene visually, but also can learn a content overview under each viewing scene from the text description, which can mutually complement each other to enhance the display effect, thereby improving the utilization rate of resources.

In a possible implementation, when displaying the scene representation information of the viewing scene, a default display of the multimedia display page can be displayed together with the scene representation information as an option, so that it is convenient to switch back to the default display of the multimedia display page. For example, the first multimedia resource is displayed by default, it is convenient to switch back to displaying the first multimedia resource. As shown in FIG. 6a, in response to the scene selection instruction, the method may further include: displaying return representation information corresponding to the first multimedia resource. The return representation information may be in the form of text, multimedia, or the like, which is not limited in the disclosure. When the return representation information is triggered, the multimedia display page is switched back to display the first multimedia resource, i.e., switching back to the default display of the multimedia display page. It is understood that the multimedia display page has a default display mode and a viewing scene display mode. In the default display mode, a selection of a viewing scene can be triggered. After a viewing scene is selected, the multimedia resources under the selected viewing scene can be browsed. Correspondingly, it is also possible to switch back to the default display mode under any viewing scene.

In a possible implementation, the at least one viewing scene may be a plurality of viewing scenes, the scene representation information may include at least one of: a plurality of pieces of multimedia preview information, scene titles, and a plurality of scene switching controls, the return representation information includes at least one of: resource preview information of the first multimedia resource, a return title, and a return control, and the method further includes:
in response to a switching operation between the plurality of pieces of multimedia preview information and the resource preview information, switching to display corresponding multimedia preview information or the resource preview information on the multimedia display page, and switching to display a corresponding scene title or the return title. That is, the display of the scene title and the return title may follow the display of the multimedia preview information or the resource preview information correspondingly; or
in response to a switching operation between the plurality of scene switching control and the return control, switching to display a corresponding scene switching control or the return control on the multimedia display page; or
in response to the switching operation between the plurality of pieces of multimedia preview information and the resource preview information, switching to display corresponding multimedia preview information or the resource preview information on the multimedia display page, and switching to display a corresponding scene switching control or the return control, as shown in FIG. 7; or
in response to the switching operation between the plurality of scene switching controls and the return control, switching to display a corresponding scene switching control or the return control on the multimedia display page, and switching to display corresponding multimedia preview information or the resource preview information, as shown in FIG. 7.

By switching to display the scene representation information, the user can flexibly and conveniently browse different viewing scenes and conveniently return to the display of the first multimedia resource.

In a possible implementation, in a process of the switching operation, switching to display the return control is replaced by: controlling the return control to be always displayed. As illustrated in FIG. 7, the return control of “selected content” can be always displayed. Correspondingly, when sliding a scene switching control to be adjacent to the return control of “selected content”, if continuous sliding is detected, the scene switching control adjacent to the return control of “selected content” can be hidden, i.e., those that have been viewed can be hidden. Correspondingly, if the user slides to the opposite direction, the hidden scene switching control can be displayed again. By always displaying the return control on the multimedia display page, it is easy to quickly switch back to displaying the first multimedia resource.

In an embodiment of the disclosure, any viewing scene may be selected from the at least one viewing scene, so that the multimedia resources can be browsed under any viewing scene. Correspondingly, the method may further include: in response to an instruction triggering target scene representation information in a plurality of pieces of scene representation information, switching to display a second multimedia resource under a target viewing scene on the multimedia display page, in which the target viewing scene may be a viewing scene corresponding to the target scene representation information.

For example, the second multimedia resource under the target viewing scene may be a multimedia resource ranked first in a sequence of recommended multimedia resources under the target viewing scene.

With the instruction for triggering the target scene representation information, the selected viewing scene can be entered flexibly and conveniently to enhance the user experience.

In a possible implementation, the multimedia display page can be a multimedia recommendation page for displaying a recommended multimedia resource. The multimedia recommendation page can include a default display mode and a viewing-scene display mode. Correspondingly, the second multimedia resource under the target viewing scene in the viewing-scene display mode may be recommended based on resource interaction information under the target viewing scene. Alternatively, resource association information of the second multimedia resource under the target viewing scene in the viewing-scene display mode is different from resource association information of a multimedia resource displayed on the multimedia display page under the default display mode. The resource association information is used to represent a content type or a resource quality of a multimedia resource, such as an exploration scene described below. That is, the exploration scene may also be used as at least one viewing scene along with other non-exploration scenes for display and selection.

The multimedia resources in the default display mode can be recommended based on integrated interaction information, which can be obtained by integrating based on resource interaction information respectively corresponding to multiple viewing scenes and interaction information on the multimedia recommendation page under a non-viewing scene. That is, the integrated interaction information can be obtained by integrating the resource interaction information respectively corresponding to the multiple viewing scenes and the interaction information of the multimedia recommendation page in the default display mode, which enables recommendations in the default display mode to be dynamically adjusted. The resource interaction information and the interaction information may include, but are not limited to, a viewing duration of a multimedia resource, forwarding a multimedia resource, etc., which is not limited in the disclosure.

For example, the integration here may be based on a recommendation weight corresponding to each viewing scene to balance the resource interaction information under each viewing scene. The recommendation weight may be preset, e.g., may be set by the user or automatically set by a multimedia application, which is not limited in the disclosure. Through differentiated settings of the resource interaction information and the integrated interaction information under various viewing scenes, fine-grained recommendation and scene0-based recommendation under respective viewing scenes can be realized, to effectively satisfy the user need. Moreover, the impact of the preferences under various viewing scene on the overall recommendations on the multimedia recommendation page can be balanced, which can effectively maintain stable preferences and meet the flexible preferences, without needing to manually set the browsing preferences in the default display mode, so as to improve the user experience.

For example, the integrated interaction information can be obtained by the following equation, Cᵢ=Σⱼ₌₁^{N}wⱼcᵢ^{j}+wₘc^{m}, where Cᵢ represents the integrated interaction information under the i^{th} content tag, such as the number of forwarding times, N is a number of types of viewing scenes, cᵢ^{j} represents the resource interaction information corresponding to the j^{th} viewing scene under the i^{th} content tag, wⱼ represents a recommendation weight corresponding to the j^{th} viewing scene, wₘ represents a recommendation weight corresponding to the default display mode, and c^{m} represents the interaction information under the default display mode. Similarly, the integrated interaction information under various content tags can be obtained.

As a possible implementation, the multimedia resources corresponding to different viewing scenes can be obtaining by screening based on different recommendation strategies.

Optionally, the method further includes: in response to a return instruction to return to the first multimedia resource, switching to display the first multimedia resource. By setting the return instruction to return to the first multimedia resource, it is possible to quickly switch back to display the first multimedia resource.

In an optional implementation, when displaying the first multimedia resource, the multimedia display page also displays an interaction control and interaction information. For example, the interaction control may be as the controls displayed on the right side of the multimedia display page in FIG. 3. The interaction information may be as the interaction information displayed on the lower left side of the multimedia display page in FIG. 3, such as comment information, music information, etc.

On the basis, in response to the scene selection instruction, displaying the corresponding scene representation information respectively corresponding to the plurality of viewing scenes on the multimedia display page may include: in response to the scene selection instruction, displaying the scene representation information respectively corresponding to the plurality of viewing scenes, and hiding the interaction control and the interaction information, such as switching from FIG. 3 to FIG. 6a. That is, when switching the display mode, the first multimedia resource is hidden.

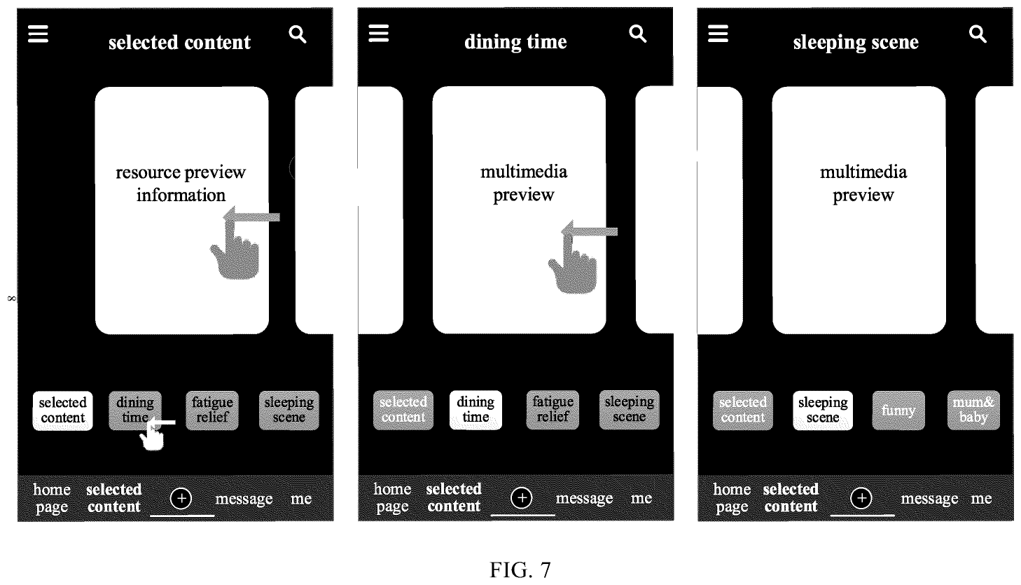

Correspondingly, in response to the instruction triggering the target scene representation information in a plurality of pieces of the scene representation information, switching to display the second multimedia resource under the target viewing scene on the multimedia display page may include: in response to the instruction triggering the target scene representation information, switching to display the second multimedia resource on the multimedia display page, and displaying the interaction control and the interaction information, for example, a switching process of S3 in FIG. 8. That is, the interaction control and the interaction information displayed under the default display mode can also be displayed when browsing multimedia resources under any viewing scene. That is, both the default display mode and the viewing-scene display mode can use a page layout of the multimedia display page used when displaying the multimedia resources.

It should be noted that the interaction control and the interaction information may be corresponding to the multimedia resource currently displayed.

By hiding and re-displaying the interaction control and the interaction information, it is possible to save display resources during the displaying and switching process of the viewing scenes, to save display resources and maintain the interaction function of the multimedia display page in the process of displaying the multimedia resources.

In the embodiment of the disclosure, the viewing scene may have an associated viewing assistance operation. On the basis, the method may further include: displaying indication information of a viewing assistance operation in a process of displaying the second multimedia resource; and in response to an execution instruction to perform the viewing assistance operation, performing an operation corresponding to the viewing assistance operation. For example, the indication information of the viewing assistance operation may be 81 as shown in FIG. 8.

Optionally, when the viewing assistance operation exists under the target viewing scene, the indication information of the viewing assistance operation may be displayed during the process of displaying the second multimedia resource. In response to the execution instruction to perform the viewing assistance operation, an operation corresponding to the viewing assistance operation is performed. Optionally, the indication information of the viewing assistance operation may be hidden after the indication information is displayed for a preset length of time period, to avoid interference with the video display.

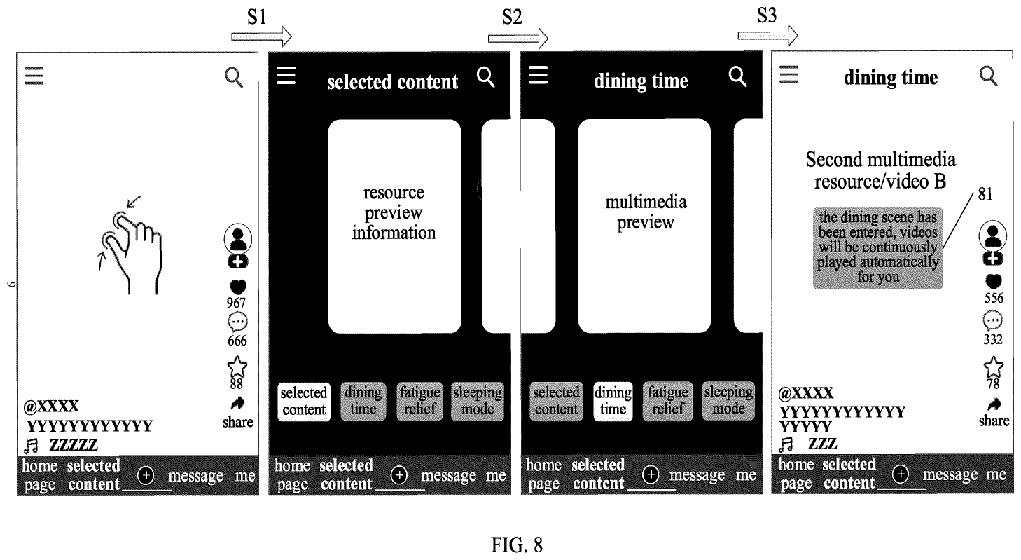

For example, the dining scene (i.e., the viewing scene of the dining time) may have an assistance operation of automatic continuous play, so that both hands can be freed during the dining time, and it is unnecessary to frequently slide up and down to browse different short videos when browsing short videos. Optionally, for example, when switching from the rightmost part (the last part) in FIG. 8 to FIG. 9, an execution instruction of the viewing assistance operation may be triggered after playing video B under the dining scene. Correspondingly, in response to the execution instruction of the viewing assistance operation, video C (i.e., the next video) may be automatically played.

Alternatively, for example, the sleeping scene may have a viewing assistance operation for counting down to exit the application. In the sleeping scene, cozy music, audiobooks and other videos may be recommended, and countdown information for exiting the application (which refers to a multimedia application herein) may be presented, and an execution instruction of the viewing assistance operation may be triggered at the end of the countdown. Correspondingly, in response to the execution instruction of the viewing assistance operation, the application may exit automatically.

By setting the viewing assistance operation associated to the viewing scene and automatically performing the operation under the viewing scene based on the viewing assistance operation, appropriate content can be recommended under the viewing scene and the need of the user under the viewing scene can be satisfied.

In an application example, with reference to a first part at the leftmost of FIG. 8, by pinching using two fingers on a video playback area during viewing videos, a second part (second from the left) in FIG. 8 can be displayed, to enter viewing scene selection. As shown in a third part (third from the left) of in FIG. 8, sliding left and right may be performed on the multimedia preview information or the scene switching controls to browse the multimedia preview information and the scene switching controls under different viewing scenes. For example, by clicking the multimedia preview information or the scene switching control corresponding to the dining time, the viewing scene of the dining time can be accessed and the video B under the viewing scene of dining time can be viewed, as shown in a fourth part (fourth from the left) shown in FIG. 8. Moreover, the indication information of the viewing assistance operation may be displayed, such as indication information for automatic continuous play, such as 81 shown in FIG. 8. Optionally, the scene title of the current viewing scene can be displayed at the top of the multimedia recommendation page. Under the viewing scene of dining time, the interaction information and the interaction control can be displayed again, at this time, the mode of viewing videos can be similar to that under the default display mode, with well viewing experience but no abruptness. The first to fourth parts are arranged in order from left to right.

Further, at the end of playback of video B, video C can be automatically played, which can be a video adjacent to video B in the sequence of recommended videos under the viewing scene of dining time.

Optionally, if the user wants return to view the first multimedia resource, by clicking a navigation control of “selected content”, it may return to the default display mode. Alternatively, by pinching using two fingers on the video playback area, a display page similar to the second part as shown in FIG. 8 may be displayed. The user can select another viewing scene, or can return to the default display mode by clicking on the resource preview information or the return control.

In an optional implementation, when the scene selection instruction is triggered, a viewing scene may be displayed at first. For example, when the at least one viewing scene includes a first viewing scene, the first viewing scene may be displayed firstly. Resource association information of a multimedia resource displayed under the first viewing scene may be different from resource association information of a multimedia resource displayed on the multimedia display page under the default display mode. That is, the first viewing scene can be an exploration scene that tries to mine the preferences of the target account, to show the target account other multimedia resources that are different from the historical preferences.

The resource association information may be used to represent at least one of the followings: a content type of the multimedia resource, a resource quality, and a recommendation strategy. The content type may include beauty makeup, baby supplemental food, etc. The content type may refer to a content tag labeled for the multimedia resources in the multimedia application, and is not limited in the disclosure. The resource quality may be used to represent a visual effect of a multimedia resource, such as definition, etc. The recommendation strategy may include, but is not limited to, random recommendation, recommendation based on a post time of multimedia resources, preference recommendation based on friend relationship, user-based preference recommendation, etc., which is not limited in the disclosure.

Correspondingly, in response to the scene selection instruction, displaying the scene representation information respectively corresponding to the at least one viewing scene on the multimedia display page in the process of displaying the first multimedia resource, may include: in response to the scene selection instruction, displaying scene representation information corresponding to a first viewing scene on the multimedia display page in the process of displaying the first multimedia resource. The scene representation information corresponding to the first viewing scene is trigger entry information for updating the multimedia resource, and is configured to update the multimedia resource recommended on the multimedia display page.

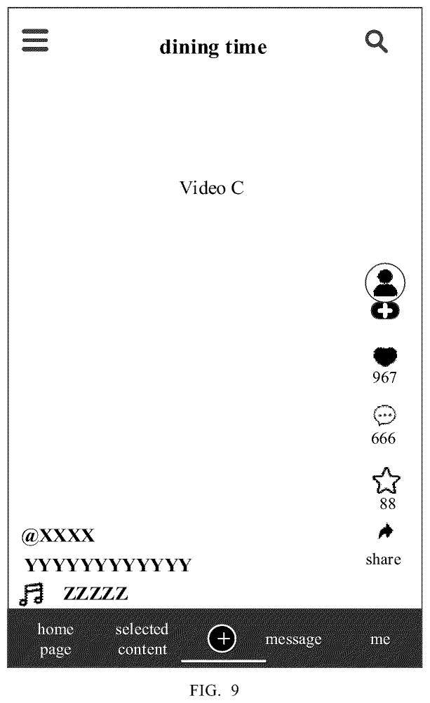

In an example, as shown in FIG. 10, the scene representation information corresponding to the first viewing scene can be “refreshing” as shown in FIG. 10 with a corresponding icon “◯”. Correspondingly, in the process of displaying the first multimedia resource, in response to the scene selection instruction, the navigation control of “selected content” on the multimedia display page may be replaced with the scene representation information corresponding to the first viewing scene, as shown in the first part in FIG. 10, which is at the leftmost of FIG. 10, and the diagram parts below are numbered in an order from the leftmost to the right most of FIG. 10. The navigation control of “selected content” may be a navigation control that indicates the multimedia display page.

By means of the scene representation information corresponding to the first viewing scene, the target account can be provided with a fresh content exploration experience, and the multimedia display is more flexible and rich.

Optionally, if the scene representation information corresponding to the first viewing scene is triggered, the first viewing scene can be entered, such as shown in the second diagram part in FIG. 10, so that multimedia resources can be browsed under the first viewing scene, such as video D shown in FIG. 10.

Based on the first viewing scene described above, the method may further include: in response to a number of times of triggering the scene representation information corresponding to the first viewing scene reaching a number threshold, displaying scene representation information respectively corresponding to at least two second viewing scenes on the multimedia display page. Multimedia resources under the second viewing scene are recommended based on resource interaction information under the second viewing scene.

It is understood that the multimedia resources displayed under the first viewing scene do not match the integrated interaction information, i.e., not match a content preference or a resource quality indicated by the integrated interaction information. For example, if content preferences indicated by the integrated interaction information are content type A and content type B, multimedia resources that do not match content type A and content type B are recommended under the first viewing scene. In the default display mode, multimedia resources matching content type A and content type B are recommended. Under each viewing scene, multimedia resources are recommended and displayed independently based on the resource interaction information under each viewing scene.

The number of times of triggering the scene representation information corresponding to the first viewing scene reaching the number threshold can be used to represent that the multimedia resources displayed under the first viewing scene do not match the content preferences of the target account. By the multimedia display under the exploration scene, the second viewing scene is further displayed in the case of not satisfying the interest preference of the account, so that the account can choose the non-exploration viewing scene, to improve the recommendation accuracy of the account.

With reference to the lower rightmost part of FIG. 10, the multimedia display page may be switched to display the scene representation information respectively corresponding to the at least two second viewing scenes, such as dining time, fatigue relief, and sleeping scene.

Optionally, with reference to the upper rightmost part of FIG. 10, the method may further include: in response to a number of times of triggering the scene representation information corresponding to the first viewing scene reaching a number threshold, switching to a default display mode on the multimedia display page. For example, video E is currently displayed at the upper rightmost part of FIG. 10.

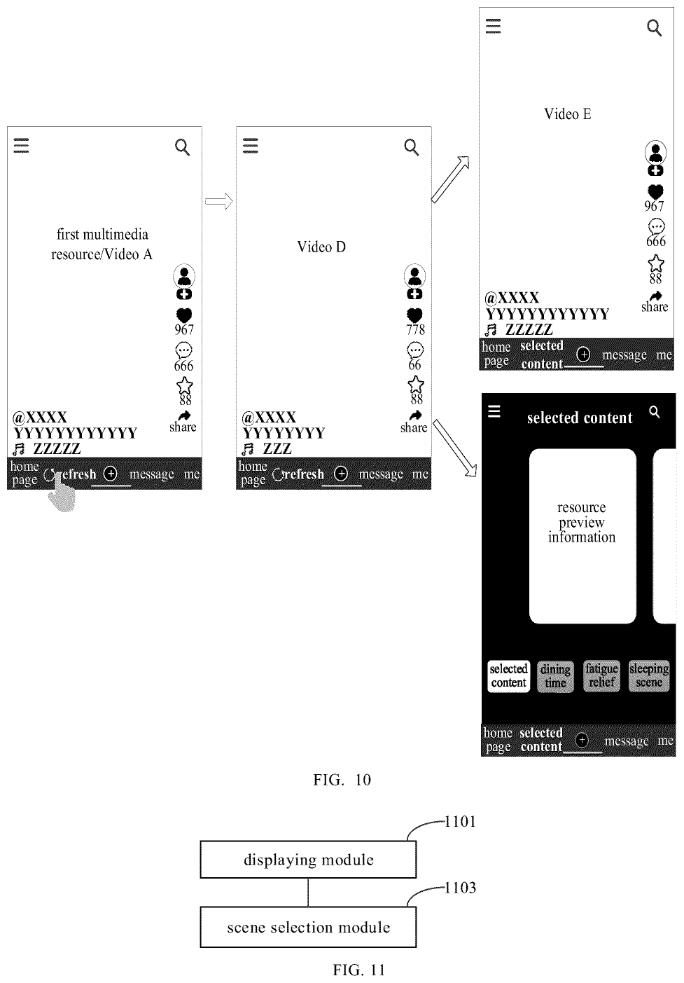

FIG. 11 is a block diagram of an apparatus for displaying a multimedia resource according to an exemplary embodiment. As illustrated in FIG. 11, the apparatus includes:
a displaying module 1101, configured to display a first multimedia resource on a multimedia display page;
a scene selection module 1103, configured to, in response to a scene selection instruction, display scene representation information respectively corresponding to at least one viewing scene on the multimedia display page in a process of displaying the first multimedia resource; in which
the scene representation information is configured to represent a corresponding viewing scene, and enter the corresponding viewing scene to browse a multimedia resource under the corresponding viewing scene in response to the scene representation information being triggered.

In a possible implementation, the apparatus further includes:
a scene switching display module, configured to, in response to an instruction triggering target scene representation information in at least one piece of the scene representation information, switch to display a second multimedia resource under a target viewing scene on the multimedia display page, in which the target viewing scene is a viewing scene corresponding to the target scene representation information.

In a possible implementation, the displaying module 1101 is further configured to display an interaction control and interaction information, and the scene selection module 1103 may include:
a first scene selection unit, configured to, in response to the scene selection instruction, display scene representation information respectively corresponding to a plurality of viewing scenes on the multimedia display page, and hide the interaction control and the interaction information.

In a possible implementation, the scene switching display module includes:
a scene switching display unit, configured to, in response to the instruction triggering the target scene representation information, switch to display the second multimedia resource on the multimedia display page, and display the interaction control and the interaction information.

In a possible implementation, the apparatus further includes:
a returning module, configured to, in response to a return instruction to return to the first multimedia resource, switch to display the first multimedia resource.

In a possible implementation, the at least one viewing scene includes a plurality of viewing scenes, the scene representation information includes a plurality of pieces of multimedia preview information and corresponding scene titles, or the scene representation information includes a plurality of scene switching controls, or the scene representation information includes the plurality of pieces of multimedia preview information and the plurality of scene switching controls.

In response to the scene representation information including the plurality of pieces of multimedia preview information and the plurality of scene switching controls, the apparatus further includes: a first scene browsing module, configured to execute any one of the followings:
in response to a switching instruction for the plurality of pieces of multimedia preview information, switching between the plurality of pieces of multimedia preview information for display, and controlling the plurality of scene switching controls to switch following the display of the plurality of pieces of multimedia preview information; or
in response to a switching instruction for the plurality of scene switching controls, switching between the plurality of scene switching controls, and controlling the plurality of pieces of multimedia preview information to switch following the display of the plurality of scene switching controls.

In a possible implementation, the scene selection module 1103 is further configured to display return representation information corresponding to the first multimedia resource.

In a possible implementation, the at least one viewing scene includes a plurality of viewing scenes, the scene representation information includes at least one of: a plurality of pieces of multimedia preview information, scene titles, and a plurality scene switching controls, the return representation information includes at least one of: resource preview information of the first multimedia resource, a return title, and a return control, the apparatus further includes: a second scene browsing module, configured to execute any one of the followings:
in response to a switching operation between the plurality of pieces of multimedia preview information and the resource preview information, switching to display corresponding multimedia preview information or the resource preview information on the multimedia display page, and switching to display a corresponding scene title or the return title; or
in response to a switching operation between the plurality of scene switching controls and the return control, switching to display a corresponding scene switching control or the return control on the multimedia display page; or
in response to the switching operation between the plurality of pieces of multimedia preview information and the resource preview information, switching to display corresponding multimedia preview information or the resource preview information on the multimedia display page, and switching to display a corresponding scene switching control or the return control; or
in response to the switching operation between the plurality of scene switching controls and the return control, switching to display a corresponding scene switching control or the return control on the multimedia display page, and switching to display corresponding multimedia preview information or the resource preview information.

In a possible implementation, the second scene browsing module is further configured to control the return control to be always displayed.

In a possible implementation, the apparatus further includes:
an assistance operation prompt module, configured to display indication information of a viewing assistance operation in a process of displaying the second multimedia resource; and
an assistance operation execution module, configured to, in response to an execution instruction to perform the viewing assistance operation, perform an operation corresponding to the viewing assistance operation.

In a possible implementation, the scene selection module includes:
a second scene selection unit, configured to, in response to the scene selection instruction, display scene representation information corresponding to a first viewing scene on the multimedia display page in the process of displaying the first multimedia resource, in which the scene representation information corresponding to the first viewing scene is trigger entry information for updating the multimedia resource and is configured to update the multimedia resources recommended on the multimedia display page.

In a possible implementation, resource association information of a multimedia resource corresponding to the first viewing scene is different from resource association information of the first multimedia resource, the resource association information may represent at least one of: a content type corresponding to the multimedia resource, a resource quality, and a recommendation strategy.

In a possible implementation, the apparatus further includes:
a scene switching module, configured to, in response to a number of times of triggering the scene representation information corresponding to the first viewing scene reaching a number threshold, display scene representation information respectively corresponding to at least two second viewing scenes on the multimedia display page.

In a possible implementation, the apparatus further includes:
a scene selection trigger module, configured to, in response to interaction information of a target account on the multimedia display page not satisfying an interaction condition, generate the scene selection instruction.

In a possible implementation, the scene selection instruction is triggered by at least one of the followings: a shrinking operation on a display page of the first multimedia resource, or a preset operation mode existing on the multimedia display page, or a current time point being within a preset scene selection time period.

With respect to the apparatus in the above embodiments, the specific manner in which each module performs an operation has been described in detail in the method embodiments, and will not be described in detail herein.

The technical solutions provided in the embodiments of the disclosure bring at least the following beneficial effects.

In response to the scene selection instruction, the scene representation information respectively corresponding to the at least one viewing scene is displayed on the multimedia display page in the process of displaying the first multimedia resource. The scene representation information is configured to represent a corresponding viewing scene and enter the corresponding viewing scene to browse a multimedia resource under the viewing scene when the scene representation information is triggered. Therefore, the user can efficiently and conveniently switch to the preferred viewing scenes according to the current state, and can browse the multimedia resources of interest without re-adjusting the preferred content types, which provides the user with more precise choices of scene-based multimedia display.

Moreover, since the viewing scenes can effectively reflect the user's viewing state and is easy to understand, the user can accurately and conveniently choose the preferred viewing scene, thereby improving the multimedia resource browsing experience and browsing effect and improving the utilization rate of display resources. The respective scene representation information respectively corresponding to the at least one viewing scene is also displayed on the multimedia display page, which makes the operation more convenient.

In addition, the preferred content types do not need to be adjusted, and the multimedia is displayed on the multimedia display page according to different scenes, which allows for displaying corresponding multimedia under various viewing scenes respectively, and does not fix the content types of multimedia resources displayed on the multimedia display page. In this way, the browsing needs of the users in different states or at different times can be satisfied flexibly, and the overall impact on displaying the multimedia resources on the multimedia display page can be avoided.

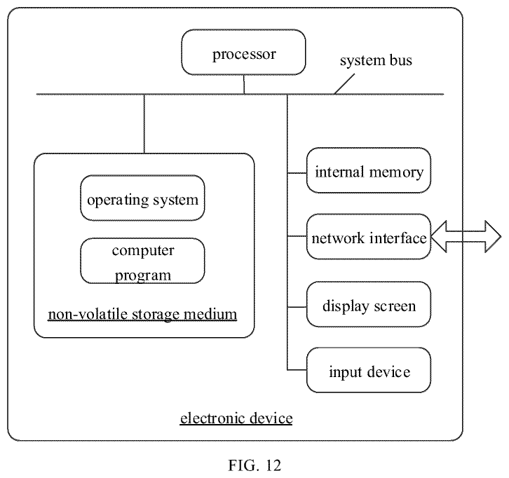

FIG. 12 is a block diagram of an electronic device for displaying a multimedia resource according to an exemplary embodiment. The electronic device may be a terminal, and the internal structure of which may be shown in FIG. 12. The electronic device includes a processor, a memory, a network interface, a display screen, and an input device that are connected via system buses. The processor of the electronic device is used to provide computing and control capabilities. The memory of the electronic device includes a non-volatile storage medium and an internal memory. The non-volatile storage medium stores an operating system and computer programs. The internal memory provides an environment for running the operating system and the computer programs in the non-volatile storage medium. The network interface of the electronic device is used to communicate with an external terminal via a network connection. The computer programs are executed by the processor to implement the method for displaying a multimedia resource. The display screen of the electronic device may be a liquid crystal display or an electronic ink display. The input device of the electronic device may be a touch layer covered on the display screen, or a button, a trackball or a touchpad provided on a housing of the electronic device, or an external keyboard, a touchpad or a mouse.

It is understood by those skilled in the art that the structure illustrated in FIG. 12 is only a block diagram of a portion of the structure related to the solutions of the disclosure, and does not constitute a limitation on the electronic device to which the solutions of the disclosure are applied. The specific electronic device may include more or fewer components than those shown in the figures, or include combined components, or have different arrangements of components.

In an exemplary embodiment, an electronic device is provided. The electronic device includes: a processor and a memory for storing instructions executable by the processor. The processor is configured to execute the instructions to implement the method for displaying a multimedia resource in the embodiments of the disclosure.

In an exemplary embodiment, a computer-readable storage medium having instructions stored thereon is provided. When the instructions are executed by a processor of the electronic device, the electronic device is caused to implement the method for displaying a multimedia resource in the embodiments of the disclosure. The computer-readable storage medium can be a read-only memory (ROM), a random access memory (RAM), a CD-ROM, a magnetic tape, a floppy disk, and an optical data storage device.

In an exemplary embodiment, a computer program product including instructions is provided. When the instructions are run by a computer, the computer is caused to implement the method for displaying a multimedia resource in the embodiments of the disclosure.

It is understood by those skilled in the art that all or part of the processes in the method embodiments described above can be implemented by instructing associated hardware through computer programs. The computer programs may be stored in a non-volatile computer-readable storage medium. When the computer programs are executed, the processes of the method embodiments described above may be implemented. Any reference to the memory, storage, database, or other mediums used in the embodiments of this disclosure may include non-volatile and/or volatile memories. The non-volatile memory may include a ROM, a programmable ROM (PROM), an electrically programmable ROM (EPROM), an electrically erasable programmable ROM (EEPROM), or a flash memory. The volatile memory may include a RAM or an external cache memory. By way of illustration and not limitation, the RAM is available in a variety of forms, such as a static RAM (SRAM), a dynamic RAM (DRAM), a synchronous DRAM (SDRAM), a dual data rate SDRAM (DDRSDRAM), an enhanced SDRAM (ESDRAM), a Synchlink DRAM (SLDRAM), a Rambus direct RDRAM (RDRAM), a direct Rambus dynamic RAM (DRDRAM), and a Rambus dynamic RAM (RDRAM).

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the disclosure as come within known or customary practice in the art. It is intended that the specification and examples be considered as exemplary only, with a true scope and spirit of the disclosure being indicated by the following claims.

It will be appreciated that the disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A method for displaying a multimedia resource, comprising:
displaying a first multimedia resource on a multimedia display page;
in response to a scene selection instruction, displaying scene representation information respectively corresponding to at least one viewing scene on the multimedia display page in a process of displaying the first multimedia resource; wherein
the scene representation information is configured to represent a corresponding viewing scene, and enter the corresponding viewing scene to browse a multimedia resource under the corresponding viewing scene in response to the scene representation information being triggered.

2. The method of claim 1, further comprising:
switching to display a second multimedia resource under a target viewing scene on the multimedia display page in response to an instruction triggering target scene representation information in at least one piece of the scene representation information, wherein the target viewing scene is a viewing scene corresponding to the target scene representation information.

3. The method of claim 2, wherein the multimedia display page displays an interaction control and interaction information when displaying the first multimedia resource, and in response to the scene selection instruction, displaying the scene representation information respectively corresponding to the at least one viewing scene on the multimedia display page, comprises:
in response to the scene selection instruction, displaying the scene representation information respectively corresponding to at least one of viewing scene on the multimedia display page, and hiding the interaction control and the interaction information.

4. The method of claim 3, wherein switching to display the second multimedia resource under the target viewing scene on the multimedia display page in response to the instruction triggering the target scene representation information in at least one of piece of the scene representation information comprises:
in response to the instruction triggering the target scene representation information, switching to display the second multimedia resource on the multimedia display page, and displaying the interaction control and the interaction information.

5. The method of claim 2, further comprising:
in response to a return instruction to return to the first multimedia resource, switching to display the first multimedia resource.

6. The method of claim 1, wherein the at least one viewing scene comprises a plurality of viewing scenes, the scene representation information comprises a plurality of pieces of multimedia preview information and corresponding scene titles, or the scene representation information comprises a plurality of scene switching controls, or the scene representation information comprises the plurality of pieces of multimedia preview information and the plurality of scene switching controls;
in response to the scene representation information comprising the plurality of pieces of multimedia preview information and the plurality of scene switching control, the method further comprises:
in response to a switching instruction for the plurality of pieces of multimedia preview information, switching between the plurality of pieces of multimedia preview information for display, and controlling the plurality of scene switching controls to switch following the display of the plurality of pieces of multimedia preview information;
or,
in response to a switching instruction for the plurality of scene switching controls, switching between the plurality of scene switching controls, and controlling the plurality of pieces of multimedia preview information to switch following the display of the plurality of scene switching controls.

7. The method of claim 1, wherein in response to the scene selection instruction, the method further comprises:
displaying return representation information corresponding to the first multimedia resource.

8. The method of claim 7, wherein the at least one viewing scene comprises a plurality of viewing scenes, the scene representation information comprises at least one of: a plurality of pieces of multimedia preview information, scene titles, and a plurality of scene switching controls, the return representation information comprises at least one of: resource preview information of the first multimedia resource, a return title, and a return control, and the method further comprises:
in response to a switching operation between the plurality of pieces of multimedia preview information and the resource preview information, switching to display corresponding multimedia preview information or the resource preview information on the multimedia display page, and switching to display a corresponding scene title or the return title; or
in response to a switching operation between the plurality of scene switching controls and the return control, switching to display a corresponding scene switching control or the return control on the multimedia display page; or
in response to the switching operation between the plurality of pieces of multimedia preview information and the resource preview information, switching to display corresponding multimedia preview information or the resource preview information on the multimedia display page, and switching to display a corresponding scene switching control or the return control; or
in response to the switching operation between the plurality of scene switching controls and the return control, switching to display a corresponding scene switching control or the return control on the multimedia display page, and switching to display corresponding multimedia preview information or the resource preview information.

9. The method of claim 8, wherein in a process of the switching operation, switching to display the return control is replaced by: controlling the return control to be always displayed.

10. The method of claim 2, further comprising:
displaying indication information of a viewing assistance operation in a process of displaying the second multimedia resource; and
in response to an execution instruction to perform the viewing assistance operation, performing an operation corresponding to the viewing assistance operation.

11. The method of claim 1, wherein in response to the scene selection instruction, displaying the scene representation information respectively corresponding to the at least one viewing scene on the multimedia display page in the process of displaying the first multimedia resource, comprises:
in response to the scene selection instruction, displaying scene representation information corresponding to a first viewing scene on the multimedia display page in the process of displaying the first multimedia resource, wherein the scene representation information corresponding to the first viewing scene is trigger entry information for updating the multimedia resource, and is configured to update the multimedia resource recommended on the multimedia display page.

12. The method of claim 11, wherein resource association information of a multimedia resource corresponding to the first viewing scene is different from resource association information of the first multimedia resource, the resource association information may represent at least one of: a content type corresponding to the multimedia resource, a resource quality, and a recommendation strategy.

13. The method of claim 11, further comprising:
in response to a number of times of triggering the scene representation information corresponding to the first viewing scene reaching a number threshold, displaying scene representation information respectively corresponding to at least two second viewing scenes on the multimedia display page.

14. The method of claim 1, further comprising:
in response to interaction information of a target account on the multimedia display page not satisfying an interaction condition, generating the scene selection instruction.

15. The method of claim 1, wherein the scene selection instruction is triggered by at least one of: a shrinking operation on a display page of the first multimedia resource, a preset operation mode existing on the multimedia display page, or a current time point being within a preset scene selection time period.

16. An electronic device, comprising:
a processor;
a memory for storing instructions executable by the processor; wherein
the processor is configured to execute the instructions to implement a method for displaying a multimedia resource, the method comprising:
displaying a first multimedia resource on a multimedia display page;
in response to a scene selection instruction, displaying scene representation information respectively corresponding to at least one viewing scene on the multimedia display page in a process of displaying the first multimedia resource; wherein
the scene representation information is configured to represent a corresponding viewing scene, and enter the corresponding viewing scene to browse a multimedia resource under the corresponding viewing scene in response to the scene representation information being triggered.

17. The electronic device of claim 16, wherein the method further comprises:
switching to display a second multimedia resource under a target viewing scene on the multimedia display page in response to an instruction triggering target scene representation information in at least one piece of the scene representation information, wherein the target viewing scene is a viewing scene corresponding to the target scene representation information.

18. The electronic device of claim 17, wherein the multimedia display page displays an interaction control and interaction information when displaying the first multimedia resource, and in response to the scene selection instruction, displaying the scene representation information respectively corresponding to the at least one viewing scene on the multimedia display page, comprises:
in response to the scene selection instruction, displaying the scene representation information respectively corresponding to at least one of viewing scene on the multimedia display page, and hiding the interaction control and the interaction information.

19. The electronic device of claim 18, wherein switching to display the second multimedia resource under the target viewing scene on the multimedia display page in response to the instruction triggering the target scene representation information in at least one of piece of the scene representation information comprises:
in response to the instruction triggering the target scene representation information, switching to display the second multimedia resource on the multimedia display page, and displaying the interaction control and the interaction information.

20. A computer-readable storage medium having instructions stored thereon, wherein when the instructions are executed by a processor of an electronic device, the electronic device is caused to implement a method for displaying a multimedia resource, the method comprising:
displaying a first multimedia resource on a multimedia display page;
in response to a scene selection instruction, displaying scene representation information respectively corresponding to at least one viewing scene on the multimedia display page in a process of displaying the first multimedia resource; wherein
the scene representation information is configured to represent a corresponding viewing scene, and enter the corresponding viewing scene to browse a multimedia resource under the corresponding viewing scene in response to the scene representation information being triggered.
